(19) United States
(12) Patent Application Publication
(10) Pub. No.: US 2026/0048766 A1
(43) Pub. Date: Feb. 19, 2026

(54) METHOD FOR ASSISTING AN EGO VEHICLE IN CARRYING OUT A DRIVING MANEUVER IN RELATION TO AT LEAST ONE FURTHER VEHICLE

(71) Applicant: Ford Global Technologies, LLC, Dearborn, MI (US)

(72) Inventors: Elena Lazaridis, Rösrath (DE); Paul Jamnicki, Bonn (DE)

(73) Assignee: Ford Global Technologies, LLC, Dearborn, MI (US)

(21) Appl. No.: 19/272,832

(22) Filed: Jul. 17, 2025

(30) Foreign Application Priority Data
Aug. 16, 2024 (DE) 102024123391.5

(51) Int. Cl. B60W 60/00; B60W 50/14

(52) U.S. Cl. CPC B60W 60/00274; B60W 50/14; B60W 60/0017; B60W 2554/20; B60W 2554/4041; B60W 2554/4045; B60W 2554/4046; B60W 2554/408

(57) ABSTRACT

The application relates to a method for assisting an ego vehicle (6) in carrying out a driving maneuver in relation to at least one further vehicle (7, 12), wherein a detection by the ego vehicle (6) in a specific traffic situation, by means of a sensor system, as to whether the ego vehicle (6) is in a position in which it obstructs an expected driving maneuver of the at least one further vehicle (7, 12), and a subsequent response of the ego vehicle (6) to said detection if an obstruction to the at least one further vehicle (7, 12) has been determined.

### CROSS-REFERENCE TO RELATED APPLICATIONS

The present application claims priority to and the benefit of German Application No. 102024123391.5, filed Aug. 16, 2024, which is hereby incorporated by reference herein in its entirety.

### FIELD

The invention relates to a method for assisting an ego vehicle in carrying out a driving maneuver in relation to at least one further vehicle.

### BACKGROUND

DE 10 2019 202 935 B3 discloses a method for assisting an ego vehicle in carrying out a predeterminable driving maneuver, comprising the following steps: a) the ego vehicle sends a position change request and identification data relating to the at least one separate vehicle which have been collected by at least one collection apparatus of the ego vehicle, by means of which identification data the at least one separate vehicle can be identified, to a plurality of motor vehicles; b) each motor vehicle of the plurality of motor vehicles checks whether it can be identified, on the basis of the received identification data, as a separate vehicle affected by the position change request; c) the at least one motor vehicle which gives an affirmative answer to the check in step b), and thus constitutes a separate vehicle affected by the position change request, checks whether it can implement a position change value derivable from the position change request without involving further motor vehicles adjacent to it on the side facing away from the ego vehicle; d) if an affirmative answer is given to the check in step c), a control apparatus of the at least one separate vehicle controls at least one of its motor vehicle components in order to change the position by the derivable position change value, and the ego vehicle makes a turn at an intersection as a driving maneuver which involves a separate vehicle that is travelling ahead, wherein, in step a), a value of a desired minimum distance is sent as a derivable position change value to the at least one separate vehicle travelling ahead. In other words, this document discloses a method in which the ego vehicle ‘asks’ a separate vehicle for a position change so that the ego vehicle can carry out the intended driving maneuver. Such a request can constitute a safety-critical situation for the driver of the separate vehicle, since the driver cannot readily or at all recognize where this ‘request’ comes from and on what it is based.

DE 10 2006 005 022 B3 discloses a motor vehicle comprising at least one device for outputting audible and/or visual information and an associated control device which determines the information to be output and controls the output, wherein a receiving device is provided, which communicates with the control device, for a signal which is sent by an emergency vehicle having right of way and contains signal information indicating this emergency vehicle and specifying the direction of travel thereof, and the control device is designed to generate and output behavior information for the driver according to the received signal information, the signal information furthermore also containing information about the desired lane to be used by the emergency vehicle in future, and the control device being designed to take into account this information in order to generate the behavior information. This document thus describes how vehicles can clear the planned travel route of an emergency vehicle as a result of information which they receive about the approaching emergency vehicle.

WO 2020/207 631 A1 discloses a method for carrying out a driving maneuver by involving a first and a plurality of second vehicles, wherein the driving maneuver produces a gap in traffic flow that is a plurality of lanes wide, the method comprising the following steps:
a) the first vehicle requesting the gap in traffic flow periodically sends corresponding request signals at least to a plurality of second vehicles that are in the traffic flow upstream of the location of the desired gap in traffic flow;
b) the second vehicles receive these request signals, and at least the second vehicles which want to meet the request send corresponding signaling signals;
c) checking whether, on the basis of reception of the signaling signals sent in step b), a minimum number of second vehicles can be determined which are sufficient to cover the plurality of lanes of the desired gap in traffic flow and which want to meet the request;
d) if an affirmative answer is given to step c), the second vehicles participating in the driving maneuver for producing the gap in traffic flow are informed;
e) the second vehicles participating in the driving maneuver agree on the start of the driving maneuver and coordinate their trajectories with one another;
f) one of the second vehicles is designated to be the maneuver leader, the maneuver leader communicating with the first vehicle in order to transmit at least one property of the gap in traffic flow to the first vehicle; and
g) the first vehicle evaluates the at least one property of the gap in traffic flow transmitted by the maneuver leader in order to make use of the gap in traffic flow.

In view of the above, there is still room for improvement, in connection with the identified prior art, in the field of traffic systems in which vehicles are stationary at road intersections and traffic flow is thereby obstructed.

### SUMMARY

The invention is based on the object of providing an improved method, with respect to the aforementioned prior art, for assisting an ego vehicle in carrying out a driving maneuver in relation to at least one further vehicle.

A method is disclosed for assisting an ego vehicle in carrying out a driving maneuver in relation to at least one further vehicle. According to the invention, a detection is carried out by the ego vehicle in a specific traffic situation, by means of a sensor system, as to whether the ego vehicle is in a position in which it obstructs an expected driving maneuver of the at least one further vehicle, wherein a subsequent response of the ego vehicle to said detection is initiated if an obstruction to the at least one further vehicle has been determined.

Advantageous embodiments are disclosed in the dependent claims.

It should be noted that the features and measures cited individually in the following description can be combined with one another in any technically expedient manner and present further embodiments of the invention. The description also characterizes and specifies the invention in particular in connection with the figures.

The method according to the invention firstly has the advantage of a rapid response time, since the ego vehicle is stationary and can detect its traffic situation surrounding it, and only afterwards does the at least one further vehicle proceed to the vicinity of the ego vehicle, which, for example, is stationary or still moving. As a result, the ego vehicle can respond immediately after the expected driving maneuver has been detected if it has determined that it constitutes an obstruction to the expected driving maneuver of the at least one further vehicle. It is not necessary for the driver of the at least one further vehicle to first detect the traffic situation and determine that the ego vehicle is obstructing its continued driving maneuver, and to notify the driver of the ego vehicle that it is blocking its continued driving maneuver only after this determination, following which the driver of the ego vehicle must first recognize that they are constituting an obstruction for the at least one further vehicle and must respond and consider, on this basis, how they can remove this obstruction for the at least one further vehicle. This whole time loss owing to communication between the drivers and the uncertainty in the response from the ego vehicle driver are advantageously avoided by the method according to the invention. For example, longer waiting at the intersection and more congestion than necessary, and an increased collision risk between two vehicles when a vehicle attempts to squeeze through a gap or past another vehicle, are avoided. Furthermore, obstructions with which the obstructed vehicle is unable to communicate because it has not been equipped with communication means, for example as an old vehicle, can be removed.

Advantageously, the method according to the invention overall results in less congestion and sounding of horns at intersections, quicker dispersal of those waiting at an intersection and a reduced risk of extreme events owing to large vehicles turning (such as trucks, for example) or careless drivers wanting to squeeze into tight gaps.

In a preferred embodiment, if an obstruction to the at least one further vehicle has been determined, a corresponding notification is given to the driver of the ego vehicle. If the sensor system of the ego vehicle detects that said ego vehicle is constituting an obstruction to the expected driving maneuver of the at least one further vehicle, a corresponding notification can first be given to the driver of the ego vehicle. The driver thereof can then decide whether they want to respond at all and remove the obstruction to the expected driving maneuver of the at least one further vehicle. This allows the driver to retain full control over their ego vehicle and only decide whether they can or want to carry out a driving maneuver to remove the obstruction to the at least one further vehicle after they themselves have determined the surrounding situation. The driver might determine a surrounding situation which does not permit such a response to remove the obstruction (for example injury to people or damage to vehicles in the surroundings of the ego vehicle, infringement of traffic regulations or the suchlike). Only when the driver of the vehicle is sure that they can safely carry out such a driving maneuver to remove the obstruction to the expected driving maneuver of the at least one further vehicle can they actually also carry this out.

In an alternative embodiment, if an obstruction to the at least one further vehicle has been determined, the ego vehicle autonomously carries out a driving maneuver which removes the obstruction. Instead of the driver of the ego vehicle retaining full control over their vehicle, it is conceivable for the ego vehicle to carry out a driving maneuver which removes the obstruction when the determined surrounding conditions so permit. In this case too, it needs to be ensured in particular that, for example, injury to people or damage to vehicles in the surroundings of the ego vehicle, infringement of traffic regulations or the suchlike are avoided during the autonomous driving maneuver.

In a preferred embodiment, the position of the at least one further vehicle is detected in the direct surroundings of the ego vehicle. Direct surroundings in this context mean that vehicles around the ego vehicle are detected which are in the direct surroundings, in particular in front of or behind the ego vehicle (or also directly to the right or to the left of it). Therefore, using the method according to the invention, the turning of vehicles at road intersections which are stationary at traffic lights, for example on a multi-lane road, can be speeded up.

In an alternative or additional embodiment, the position of the at least one further vehicle is detected in the indirect surroundings of the ego vehicle. Indirect surroundings in this context mean that vehicles are further away from the ego vehicle than when they are in its direct surroundings. Vehicles in the indirect surroundings are, for example, vehicles which are in an intersecting roadway with respect to the roadway which the ego vehicle is in. In this case, for example, it is possible to detect in the intersecting roadway large vehicles such as trucks or suchlike which have a large turning radius when they want to turn from the intersecting roadway which they are in into the roadway which the ego vehicle is in. As a result, advantageously according to the invention, such turning can be speeded up by virtue of the stationary ego vehicle recognizing the turning of the large vehicle as its expected driving maneuver and, for example, reversing a little when stationary directly at a red set of traffic lights in order to make space accordingly for the large vehicle. Naturally, this process again requires allowance to be made for there to be sufficient space for it and in particular for further vehicles or people behind the ego vehicle not to be adversely affected. Alternatively, the ego vehicle could stop moving towards the set of traffic lights and leave sufficient space at the set of traffic lights for turning. Stopping and reversing would also be conceivable.

In a preferred embodiment, the expected driving maneuver of the at least one further vehicle is detected by means of the sensor system of the ego vehicle on the basis of external appearance features of the at least one further vehicle. This expected driving maneuver of the at least one further vehicle can, for example, be signaled by indicators, hand signals or the suchlike. In particular, the at least one further vehicle should give a clear signal by which it indicates the expected driving maneuver so that said driving maneuver can be detected by means of the sensor system of the ego vehicle.

In an alternative or additional embodiment, the expected driving maneuver of the at least one further vehicle is detected by means of the sensor system of the ego vehicle on the basis of radio communication between the vehicles. To increase reliability in indicating the expected driving maneuver of the at least one further vehicle, it is possible for said vehicle to send a corresponding signal which can be detected by means of the sensor system of the ego vehicle. This allows the response to said expected driving maneuver, when the ego vehicle constitutes an obstruction to it, to be automated and thereby the whole process to be speeded up. The V2C method, for example, can be considered for radio communication for this purpose. However, it is also conceivable for this method to be suitably supplemented by external further signals (V2X).

In a preferred embodiment, the surroundings around the ego vehicle (actual position) are detected by means of the sensor system of the ego vehicle according to the expected driving maneuver of the at least one further vehicle and a changed position (target position) of the ego vehicle is determined therefrom, in which position the obstruction to the at least one further vehicle is removed when said further vehicle carries out its expected driving maneuver. As a result, the driving maneuver of the ego vehicle from its actual position to the automatically ascertained target position can be carried out in an automated manner or it can be carried out by the driver of the ego vehicle following a corresponding notification so that the obstruction to the expected driving maneuver of the at least one vehicle is removed.

In a preferred embodiment, during a position change (from the actual position to the target position) of the ego vehicle, the latter's surroundings continue to be detected and the position change (previous target position) is changed again if the result of the position change of the ego vehicle which is carried out up to this point is that a further position change (new target position) arises, on the basis of the currently detected surroundings, in which the obstruction to the at least one further vehicle is removed, ideally removed sooner, when said further vehicle carries out its expected driving maneuver. It is initially assumed that a target position to which the ego vehicle moves from its actual position by means of its driver or autonomously is determined by means of the sensor system of the ego vehicle according to the expected driving maneuver of the at least one vehicle. However, it is conceivable for the surrounding conditions to change during this movement (for example a set of traffic lights in a lane of the road intersection turns green, which allows the ego vehicle not only to continue movement just up to the vehicle in front, but to completely clear its position and continue travelling). In this case, it is advantageously possible to take into account this change in the surrounding conditions and thereby further speed up the entire process of ego vehicle movement to remove the obstruction to the expected driving maneuver of the at least one further vehicle.

In a specific embodiment, the ego vehicle in a specific traffic situation is in a static traffic situation. This means that the ego vehicle is stationary when the expected driving maneuver is transmitted to it and it determines that it is constituting an obstruction to the at least one further vehicle. The ego vehicle can respond to this as explained above.

Alternatively, the method according to the invention can also be carried out as explained above when the ego vehicle in a specific traffic situation is in a dynamic traffic situation. This means that the ego vehicle is not yet stationary, i.e. still moving, and while moving (for example when approaching the stationary vehicle in front of it or a red set of traffic lights) already constitutes an obstruction to the expected driving maneuver of the at least one further vehicle (for example the indicated switch thereof from the straight-ahead lane to a turning lane or the large turning radius of a large vehicle).

The method according to the invention can thus be applied both to static and dynamic traffic situations of the ego vehicle.

According to the embodiments above, which apply both generally and in relation to the exemplary embodiments, it is firstly conceivable for the ego vehicle to respond only to the expected driving maneuver of a single further vehicle which it detects. However, it is also conceivable not only for the ego vehicle to respond to the expected driving maneuver of the further vehicle, but for its response thereto to be transmitted to further vehicles, for example stationary in front of it, so that a plurality of vehicles (including the ego vehicle) are moved to remove the obstruction to the expected driving maneuver of the vehicle. It is expedient in the context of the invention that the ego vehicle detects the expected driving maneuver of the further vehicle and responds to it without the vehicle that performs the expected driving maneuver transmitting its driving maneuver to the ego vehicle.

### BRIEF DESCRIPTION OF THE DRAWINGS

Further advantageous embodiments of the invention are disclosed in the dependent claims and the following description of the figures. In the drawings:

FIG. 1 shows an exemplary situation at a road intersection with a turning vehicle,

FIG. 2 shows an exemplary situation at a road intersection with a large vehicle,

FIG. 3 shows an exemplary method according to the situation according to FIG. 1, and

FIG. 4 shows an exemplary method according to the situation according to FIG. 2.

The same parts are always provided with the same reference signs in the different figures and so are generally only described once.

### DETAILED DESCRIPTION

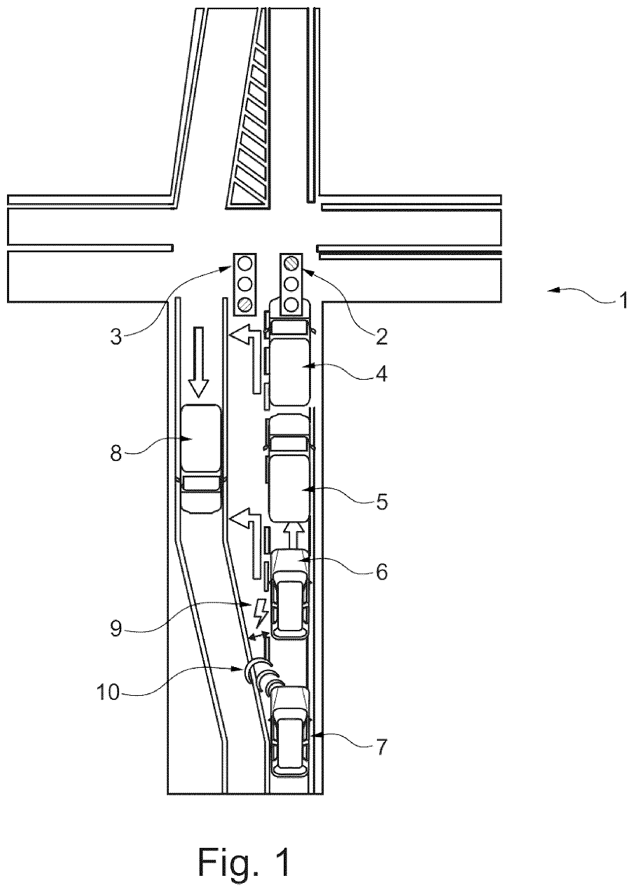

FIG. 1 shows an exemplary situation at a road intersection 1 with a turning vehicle. Two sets of traffic lights 2, 3 are located at the road intersection 1. The set of traffic lights 2 is for the lane which leads straight ahead, whereas the set of traffic lights 3 is for the left-turning traffic. By way of example, vehicles 4 and 5 and also an ego vehicle 6 behind them are stationary at the red set of traffic lights 2. At least one further vehicle 7 in turn is approaching or stationary behind the ego vehicle 6 and is seeking to switch to the left-turn lane and drive to the set of traffic lights 3, since there is space for it in the left-turn lane. However, it is blocked by the ego vehicle 6. This waiting of vehicle 7 would take time, since it would first have to wait for the set of traffic lights 2 to turn green and for the vehicles 4 to 6 to clear the straight-ahead lane so that the vehicle 7 can switch to the left-turn lane. Only by way of example, a further vehicle 8 is shown in the oncoming lane. A problem region is denoted by reference sign 9, which in this case, for example, is the region from where the left-turn lane diverges from the straight-ahead lane. This problem region 9 is insufficient (too narrow) for the vehicle 7 to pass by the ego vehicle 6. While the ego vehicle 6 is stationary and the further vehicle 7 approaches it, said vehicle 7 uses its indicator 10 to signal a turn into the left-turn lane of the road intersection 1 as an expected driving maneuver. The signal of this indicator 10 is recognized and evaluated by the sensor system of the ego vehicle 6. It can be supplemented by a radio signal or even just be a radio signal.

Therefore, the sensors of the ego vehicle 6, such as front camera, side cameras, reversing camera or V2V communication, recognize the intention of the rear vehicle 7 to turn left. The ego vehicle 6 then assesses the situation such as the distance ahead (in this case from the vehicle 5), road gradient (above the threshold value the distance from the vehicle in front must be increased), distance from the right side of the road, width of the rear vehicle 7 (if necessary including wing mirrors), appearance of the rear vehicle 7 (for example scratches on the fender), gap to reach the traffic line and to turn left, number of vehicles 8 travelling in the opposite roadway, time until the set of traffic lights 2 and/or 3 changes its current state (C2X) etc. (the above list is only by way of example and not exhaustive). This evaluation will reveal that the ego vehicle 6 is obstructing the continued driving maneuver of the vehicle 7, specifically the turning into the left-turn lane. As a result of this evaluation, this obstruction can be indicated to the driver of the ego vehicle 6. The driver can then decide whether to respond to this indication and, if so, how. If the driver responds, this can lead to them, for example, pulling their ego vehicle 6 forward a little towards the vehicle 5 stationary in front of it. Alternatively or additionally, in this specific situation, it is also conceivably possible for the driver of the ego vehicle 6 to just move to the right or a little forward and simultaneously to the right in order to make space for the vehicle 7 so that it can drive into the left-turn lane unimpeded (i.e. without its expected driving maneuver being obstructed). Naturally, it is also conceivable, in the case of this driving maneuver of the ego vehicle 6, for the vehicle 5 in front of it to not be affected or for the road verge of the straight-ahead lane not to be crossed. This driving maneuver of the ego vehicle 6 for removing the obstruction to the expected driving maneuver of the vehicle 7 can be carried out under full control of the driver of the ego vehicle 6 or autonomously. If it takes place autonomously, the autonomous driving maneuver of the ego vehicle 6 can be overridden or stopped by its driver.

FIG. 1 shows that the ego vehicle 6 in a specific traffic situation is in a static traffic situation, namely is behind the vehicle 5, while the further vehicle 7 is approaching and signaling its expected driving maneuver. Alternatively, however, the ego vehicle 6 could also be in a dynamic traffic situation, namely continuing to move towards the vehicle 5 in front of it. The ego vehicle 6 would therefore very slowly coast to a standstill. Even when coasting to a stop, in particular at a low speed, it nonetheless obstructs the expected driving maneuver of the vehicle 7 approaching it. If the ego vehicle 6 had moved close to the vehicle 5 at a greater speed and then stopped just before it, it would not have obstructed the turning maneuver of the vehicle 7. Therefore, the ego vehicle 6 in its dynamic traffic situation (for example coasting to a stop, moving at a slow and largely constant speed, reversing or the suchlike) can already recognize the obstruction and respond accordingly in order to remove the obstruction.

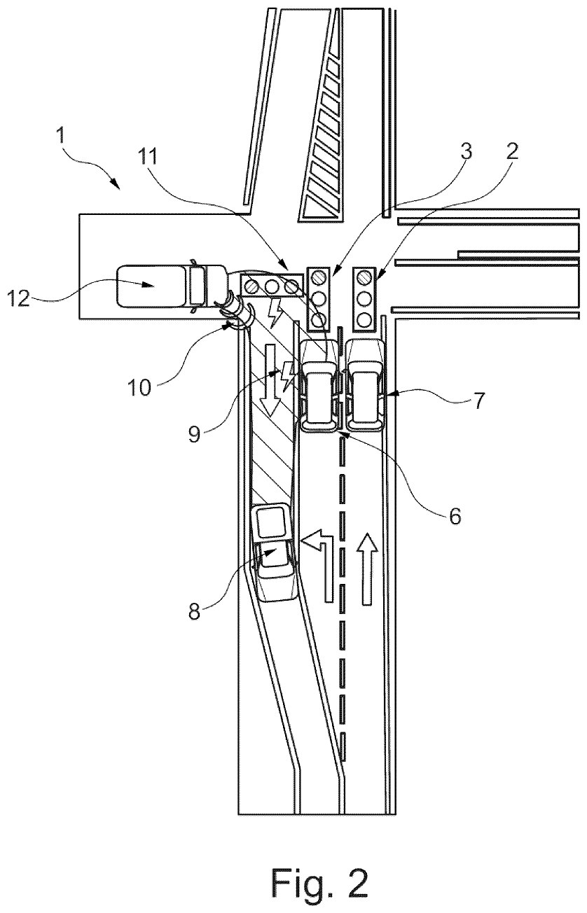

FIG. 2 shows an exemplary situation at a road intersection 1 with a further vehicle 12, for example a large vehicle. The road intersection 1 is similar to the road intersection 1 according to FIG. 1, in which there is likewise a set of traffic lights 11 in the roadway (intersecting roadway) for the straight-ahead lane and the left-turn lane. This set of traffic lights 11, which is showing green, is approached by a large vehicle, i.e. a further vehicle 12, for example a semitrailer, with a turning radius that reaches the left-turn lane of the road intersection 1. Nonetheless, the ego vehicle 6 is stationary at the set of traffic lights 3 and thus obstructs the large vehicle from turning (although it has a green light). Without the method according to the invention, the large vehicle would have to wait for the set of traffic lights 11 to turn green and until the region, in particular the problem region 9, in front of the set of traffic lights 3 is clear so that it can turn. Since, however, the large vehicle has switched on its indicator 10 (or, if applicable, has otherwise or additionally signaled its intention to turn as an expected driving maneuver), this is recognized in turn by the sensor system of the ego vehicle 6. A situation is also conceivable in this case in which the ego vehicle 6 is not yet directly at the set of traffic lights 3, but rather moving towards them, and yet is already obstructing the turning radius of the further vehicle 12, in particular the large vehicle, in the process. A corresponding response of the ego vehicle 6 to this would be, for example, reversing, at least partially switching to the adjacent lane or the suchlike.

The sensors of the ego vehicle 6, such as front camera, side cameras, reversing camera or V2V communication and suchlike, detect and assess the situation: recognition of the large vehicle (such as a truck, bus, vehicle with trailer and the suchlike) and its intention to turn right, assessment of the size and the turning radius required for turning right, assessment of the appearance, for example, of the truck (for example scratches on the fender) and examination of the region behind the ego vehicle 6 to check whether there is space for reversing.

The ego vehicle 6 now determines, likewise using this sensor system, that there is no longer a further vehicle behind it and that it is possible to reverse a little. This reversing process clears the problem region 9, i.e. it is possible for the large vehicle, i.e. for the further vehicle 12, to turn at the green set of traffic lights 11. As a result of the driver of the large vehicle switching on their indicator 10 and performing no further actions, the expected driving maneuver of the large vehicle, i.e. of the further vehicle 12, is signaled to the ego vehicle 6 and the ego vehicle 6 can either clear the problem region 9 as a result of a corresponding notification to the driver of the ego vehicle 6 or do so autonomously and thereby remove the obstruction to the driving maneuver of the large vehicle which exists up to this point.

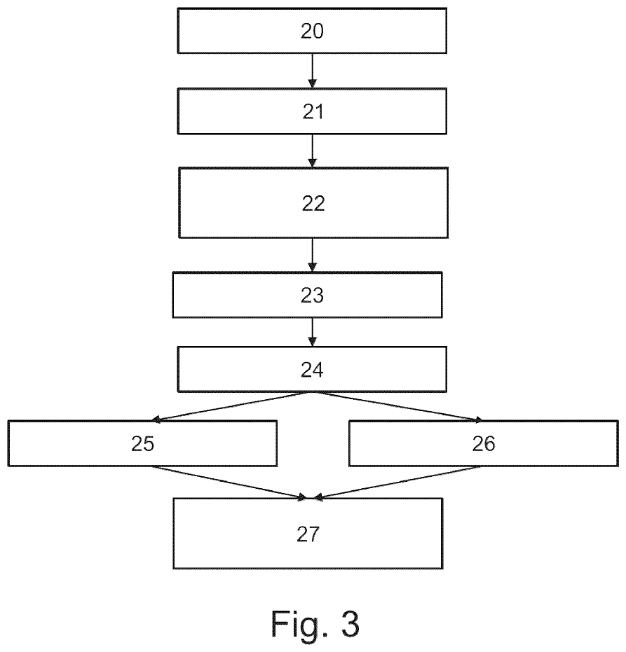

FIG. 3 shows an exemplary method corresponding to the situation according to FIG. 1. In step 20, it is assumed that the ego vehicle 6 is stationary at the road intersection 1, in particular directly or behind further vehicles at a red set of traffic lights. This means that the ego vehicle 6 has static behavior at this moment as a result of adopting an actual position. In step 21, a suitable sensor system of the ego vehicle 6 is used to detect the latter's surroundings. In step 22, it is also determined that the further vehicle 7 behind the ego vehicle 6 has the intention of turning. For example, it has switched on its indicator 10. Then, in a further step, step 23, the sensor system of the ego vehicle 6 is used to ascertain a changed (improved) target position in relation to this adopted actual position. The change (improvement) relates to the fact that the changed target position (new position) of the ego vehicle 6 no longer obstructs the further vehicle 7 behind it from turning. This new position of the ego vehicle 6 is given as information to its driver. Two different alternative steps are conceivable in response to this. In step 25, the driver, according to the information in step 24, changes the previous actual position of the ego vehicle 6 towards or completely to the new given position so that it is possible for the obstruction to the expected driving maneuver of the further vehicle 7 behind it to be removed. Alternatively, the above-described switch from the actual position of the ego vehicle 6 towards or completely to the determined, changed new position (target position) can be made autonomously by the ego vehicle 6, which is demonstrated by step 26. In step 27, the ego vehicle 6 has finally reached a target position in which it is possible for the further vehicle 7 to carry out its expected driving maneuver (in this case the turn) without obstruction from the ego vehicle 6. In each of the two above cases and also generally irrespective of the situation at the road intersection 1 shown in FIG. 1 it is conceivable for the obstruction to the expected driving maneuver of the further vehicle 7 to then be eliminated by the ego vehicle 6 and not by the further vehicle 7.

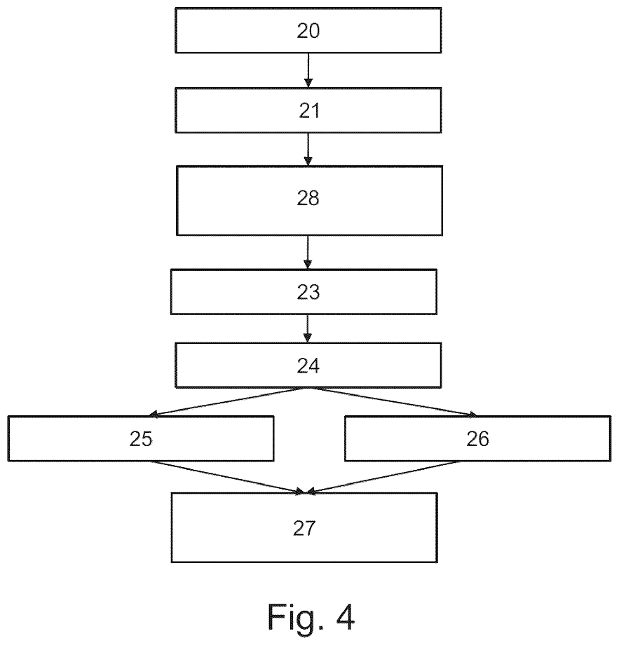

FIG. 4 shows an exemplary method corresponding to the situation according to FIG. 2. The only difference in this method is that the intention of the further vehicle 7 behind the ego vehicle 6 to turn (step 22 in FIG. 3) is not detected, but rather a turning maneuver of a large vehicle, i.e. a further vehicle 12 in the intersecting roadway at the road intersection 1, is detected in a step 28 and responded to accordingly by the ego vehicle 6.

The carrying out of the method according to the invention is not limited to road intersections, but can also be used in comparable situations (such as, for example, entrances and exits of parking lots to/from roads).

### LIST OF REFERENCE SIGNS

1 Road intersection
2 Set of traffic lights
3 Set of traffic lights
4 First vehicle
5 Further vehicle
6 Ego vehicle
7 Further vehicle
8 Oncoming vehicle
9 Problem region
10 Indicator
11 Set of traffic lights
12 Further vehicle/large vehicle

### Method Steps, FIG. 3

20 Ego vehicle is stationary at the road intersection actual position
21 Detection of the region around the ego vehicle
22 Detection of the intention of the vehicle behind the ego vehicle to turn
23 Determination of an improved target position
24 Information to the driver of the ego vehicle
25 Driver changes the position of the ego vehicle
26 Ego vehicle changes its position autonomously
27 Adopting the best possible position of the ego vehicle in this situation

### Method Steps, FIG. 4

20 Ego vehicle is stationary at the road intersection actual position
21 Detection of the region around the ego vehicle
23 Determination of an improved target position
24 Information to the driver of the ego vehicle
25 Driver changes the position of the ego vehicle
26 Ego vehicle changes its position autonomously
27 Adopting the best possible position of the ego vehicle in this situation
28 Detection of a turning maneuver of a large vehicle

1. A method for assisting an ego vehicle (6) in carrying out a driving maneuver in relation to at least one further vehicle (7, 12), the method comprising:
detecting, by the ego vehicle (6) in a specific traffic situation, by a sensor system, as to whether the ego vehicle (6) is in a position in which it obstructs an expected driving maneuver of the at least one further vehicle (7, 12), and
subsequently responding of the ego vehicle (6) to said detection based on an obstruction to the at least one further vehicle (7, 12) being determined.

2. The method according to claim 1, wherein based on an obstruction to the at least one further vehicle (7, 12) being determined, a corresponding notification is given to the driver of the ego vehicle (6).

3. The method according to claim 1, wherein based on an obstruction to the at least one further vehicle (7, 12) being determined, the ego vehicle (6) autonomously carries out a driving maneuver which removes the obstruction.

4. The method according to claim 1, wherein the position of the at least one further vehicle (7, 12) is detected in the direct and/or indirect surroundings of the ego vehicle (6).

5. The method according to claim 1, wherein the expected driving maneuver of the at least one further vehicle (7, 12) is detected by the sensor system of the ego vehicle (6) on the basis of external appearance features of the at least one further vehicle (7, 12).

6. The method according to claim 1, wherein the expected driving maneuver of the at least one further vehicle (7, 12) is detected by the sensor system of the ego vehicle (6) on the basis of radio communication between the vehicles (6; 7, 12).

7. The method according to claim 1, wherein the surroundings around the ego vehicle (6) are detected by the sensor system of the ego vehicle (6) according to the expected driving maneuver of the at least one further vehicle (7, 12) and a changed position of the ego vehicle (6) is determined therefrom, in which position the obstruction to the at least one further vehicle (7, 12) is removed when said further vehicle carries out its expected driving maneuver.

8. The method according to claim 7, wherein during a position change of the ego vehicle (6), the latter's surroundings continue to be detected and the position change is changed again if the result of the position change of the ego vehicle (6) which is carried out up to this point is that a further position change arises, on the basis of the currently detected surroundings, in which the obstruction to the at least one further vehicle (7, 12) is removed when said further vehicle carries out its expected driving maneuver.

9. The method according to claim 1, wherein the ego vehicle (6) in a specific traffic situation is in a static traffic situation.

10. The method according to claim 1, wherein the ego vehicle (6) in a specific traffic situation is in a dynamic traffic situation.
